(19) United States
(12) Patent Application Publication
(10) Pub. No.: US 2012/0062943 A1
(43) Pub. Date: Mar. 15, 2012

(54) PRINTING APPARATUS, PRINTING APPARATUS CONTROL METHOD, AND STORAGE MEDIUM

(75) Inventor: Yuuki Maeda, Yokohama-shi (JP)

(73) Assignee: CANON KABUSHIKI KAISHA, Tokyo (JP)

(21) Appl. No.: 13/222,933

(22) Filed: Aug. 31, 2011

(30) Foreign Application Priority Data
Sep. 10, 2010 (JP) 2010-202570

(51) Int. Cl. G06K 15/02

(52) U.S. Cl. 358/1.15

(57) ABSTRACT

A printing apparatus to feed tab sheets and a sheet of paper other than tab sheets and to execute printing by using the fed item. The printing apparatus includes an analysis unit, a feeding unit, and a discharge unit. In performing printing by executing the print job analyzed by the analysis unit and by inserting variable data of records into a predetermined template, the feeding unit feeds the tab sheet at a break of the variable data. The variable data is detected according to a result of the analysis by the analysis unit on the print job. The discharge unit discharges, to an outside of the printing apparatus, a tab sheet that is included in one set of tab sheets and remains unfed by the feeding unit every time variable data of one record from among the plurality of records is printed as controlled by a discharge control unit.

### BACKGROUND OF THE INVENTION

1. Field of the Invention

The present invention relates to a printing apparatus, a printing apparatus control method, and a storage medium.

2. Description of the Related Art

A conventional printing apparatus includes a function for inserting a tab paper (also referred to as a “tab sheet”) into a print product printed by executing a print job at a predetermined position of the product. The tab paper used on the printing apparatus described above is handled as one set including a plurality of number of paper sheets. For example, one set of tab paper may include five tab sheets.

In inserting three tab sheets into one copy of a print product printed by executing a print job, if one set of tab paper including five tab sheets is set to a paper feed unit and the printing is executed in this state, two surplus tab sheets remain unused after printing the first copy. If a second copy of the document is printed in the similar manner without discharging the surplus two tab sheets, the tab order of the tab sheets may become different between the first copy and the second copy.

In order to solve the above-described problem, Japanese Patent Application Publication No. 2002-003063 discusses a method for causing the tab order of tab sheets to be the same for each copy by discharging surplus tab sheets remaining on the paper feed stage (sheet storage unit) when the printing in the unit of a copy is completed.

On the other hand, commercial printing, such as print on demand (POD) printing, has been put to practical use. In a POD system, use of a method for executing printing by laying out variable data loaded from a database on a template which defines a region for inserting variable data, has been widespread.

The above-described POD system can implement variable printing, in which a part of an image to be printed differs for each predetermined output. However, if a host computer generates print data by merely combining a template and variable data together, rendered data having the same content may be repeatedly transmitted. In this case, the data amount may become large.

In a data format, such as personalized print markup language (PPML), a reusable object is defined and a reusable object is designated for each page data. In this case, a printer controller can execute printing by previously designating raster image processing (RIP) on the reusable object before the printing starts and by executing RIP on each page data after the RIP on the reusable object is completed.

In a conventional method, print data generated from a variable print job does not include a concept of a record. Accordingly, a conventional printing apparatus cannot detect a boundary between records. Japanese Patent Application Laid-Open No. 2008-269261 discusses a method for detecting a boundary between records according to a result of an analysis on a print job described in PPML.

However, if a tab paper is inserted into a print product generated by printing variable data described by a language such as PPML, if a surplus tab sheet is discharged at a break between copies, the surplus tab sheet may not be discharged at a break between records even if the break for each customer is provided between the records.

Accordingly, even if a print product into which tab sheets are inserted in order from a first tab is to be output for each customer, the tab may not be appropriately positioned in print products corresponding to a second record and beyond. For example, if variable data is to be printed by using one set of tab sheets including five sheets, which is set to the paper feed unit, and if a print product is to be output by inserting two tab sheets into the print product for each customer, the tab sheets can be appropriately inserted into a print product corresponding to the first record starting from the first tab sheet but cannot be appropriately inserted into a print product corresponding to the second record because the tab sheets are inserted into the print product corresponding to the second record starting from the third tab sheet. In this case, a print product desired by the customer may not be output.

### SUMMARY OF THE INVENTION

According to an aspect of the present invention, a printing apparatus configured to feed tab sheets from one set of a plurality of tab sheets and to feed a sheet of paper other than tab sheets and configured to execute printing by using the fed tab sheet or the fed sheet of paper other than the tab sheet, the printing apparatus includes: an analysis unit configured to analyze a received print job; a feeding unit configured, in performing printing by executing the print job analyzed by the analysis unit and by inserting variable data of a plurality of records into a predetermined template, to feed the tab sheet at a break of the variable data, wherein the variable data is detected according to a result of the analysis by the analysis unit on the print job; a discharge unit configured to discharge, to an outside of the printing apparatus, a tab sheet that is included in one set of tab sheets and remains unfed by the feeding unit; and a discharge control unit configured, every time variable data of one record from among the plurality of records is printed, to execute control to cause the discharge unit to discharge, to the outside of the printing apparatus, the tab sheet that is included in the one set of tab sheets and remains unfed by the feeding unit.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 illustrates an exemplary configuration of a printing system to which a printing apparatus according to an exemplary embodiment is to be applied.

FIG. 2 is a block diagram illustrating an exemplary configuration of the printing system illustrated in FIG. 1.

FIG. 3 illustrates an exemplary inline configuration of the printing system.

FIG. 4 is a plan view illustrating an exemplary configuration of an operation unit illustrated in FIG. 2.

FIG. 5 is a plan view illustrating an exemplary configuration of the operation unit illustrated in FIG. 2.

FIG. 6 illustrates an exemplary configuration of a touch panel unit of the operation unit illustrated in FIG. 2.

FIG. 7 is a flow chart illustrating an exemplary flow of processing executed by a printing apparatus.

FIG. 8 is a flow chart illustrating an exemplary flow of processing executed by the printing apparatus.

FIG. 9 illustrates an example of a user interface (UI) displayed on the touch panel unit illustrated in FIG. 4.

FIG. 10 illustrates an example of a UI displayed on the touch panel unit illustrated in FIG. 4.

FIG. 11 illustrates an example of a UI displayed on the touch panel unit illustrated in FIG. 4.

FIG. 12 is a flow chart illustrating an exemplary flow of processing executed by the printing apparatus.

FIG. 13 illustrates an example of a UI displayed on a touch panel unit.

FIG. 14 illustrates an example of a UI displayed on a touch panel unit.

FIG. 15 illustrates an example of a UI displayed on a touch panel unit.

### DESCRIPTION OF THE EMBODIMENTS

Various exemplary embodiments, features, and aspects of the invention will be described in detail below with reference to the drawings.

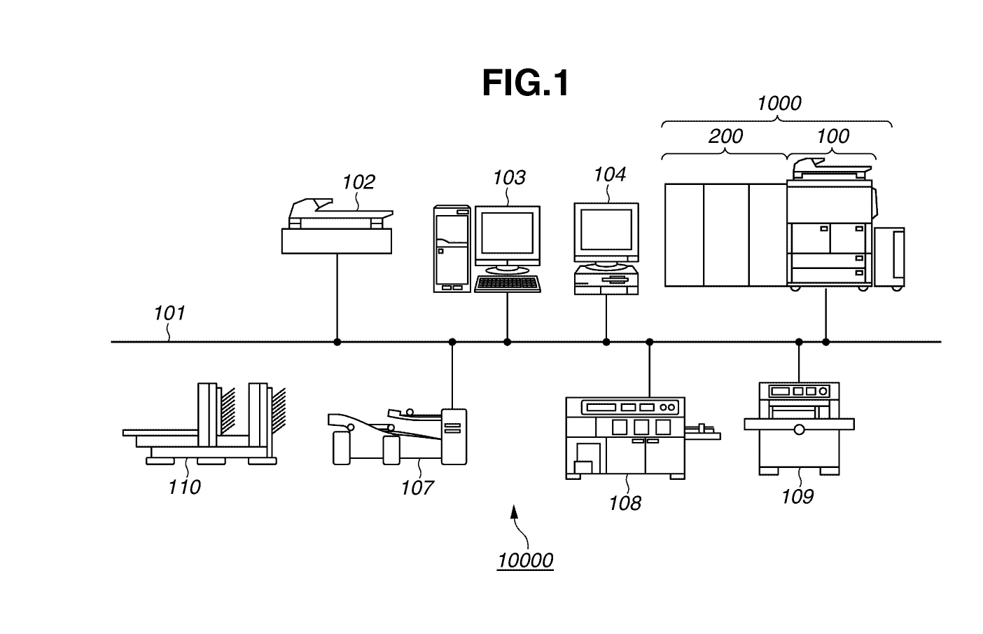

A first exemplary embodiment assumes a printing environment, such as a POD environment. To begin with, a system environment of the entire installation location of a printing system 1000 (i.e., a printing environment 10000 illustrated in FIG. 1, which is a POD environment) will be described in detail below. Such a printing environment itself is also one of characteristics of the present exemplary embodiment.

In the present exemplary embodiment, a plurality of tab sheets, which is included in one set thereof and which is stored in a paper feed stage, or a sheet other than the tab sheets, can be fed from a paper feed unit according to a result of an analysis of a print job received from an information processing apparatus. The present exemplary embodiment executes control for discharging tab sheets included in one set of tab sheets but remain unused in printing a print job to a previously designated paper discharge destination provided external to a printing apparatus.

In the present exemplary embodiment, the printing environment 10000, to which the printing system 1000 can be applied, is referred to as a POD system 10000 because the printing environment 10000 is appropriate for a POD environment.

FIG. 1 illustrates an example of a printing system to which a printing apparatus according to the present exemplary embodiment is to be applied. In a POD system (printing system) according to the present exemplary embodiment, various printing apparatuses and sheet processing apparatuses are network-connected and are used to execute print job.

Referring to FIG. 1, the POD system 10000 includes components, such as the printing system 1000, a server 103, and a client 104 according to the present exemplary embodiment. Each of the server 103 and the client 104 is a computer, such as a personal computer (PC). In addition, the POD system 10000 includes a paper folding machine 107, a cutting machine 109, a saddle stitch binding machine 110, a case binding machine 108, and a scanner 102. The above-described plurality of apparatuses is provided in the POD system 10000.

The printing system 1000 includes components, such as a printing apparatus 1000 and a sheet processing apparatus 200. In the present exemplary embodiment, a multifunction peripheral (MFP), which includes a plurality of functions, such as a copy function and a print function, is described as an example of the printing apparatus 100. However, a single-function printing apparatus having the copy function or the print function only can be used as the printing apparatus 100.

Each of the paper folding machine 107, the case binding machine 108, the cutting machine 109, and the saddle stitch binding machine 110 illustrated in FIG. 1 is defined as a sheet processing apparatus similar to the sheet processing apparatus 200 included in the printing system 1000.

In other words, the sheet processing apparatuses are devices that are capable of executing sheet processing on a sheet used in a job printed by the printing apparatus 100 included in the printing system 1000. The paper folding machine 107 can execute folding processing on a sheet used in the job printed by the printing apparatus 100.

The cutting machine 109 can execute cutting processing on a plurality of sheets printed by the printing apparatus 100. The saddle stitch binding machine 110 can execute saddle stitch binding processing on the sheet printed by the printing apparatus 100. The case binding machine 108 can execute case binding on a bundle of sheets printed by the printing apparatus 100.

However, in executing various types of sheet processing by using the above-described sheet processing apparatuses, it is necessary for an operator to remove a printed product of a job printed by the printing apparatus 100 from a paper discharge unit of the printing apparatus 100 and to set the print product on a sheet processing apparatus to be used in executing post-processing.

As described above, in utilizing the sheet processing apparatus except the sheet processing apparatus 200 included in the printing system 1000 itself, the operator is required to execute an interacting operation after print processing by the printing apparatus 100 is completed.

To paraphrase this, in executing sheet processing on a sheet printed by the printing apparatus 100 by utilizing the sheet processing apparatus 200 included in the printing system 1000 itself, the operator is not required to execute an interacting operation after the print processing by the printing apparatus 100. This is because a sheet printed by the printing apparatus 100 can be fed directly from the printing apparatus 100 to the sheet processing apparatus 200 in the present exemplary embodiment.

More specifically, a sheet conveyance path included in the printing apparatus 100 can be connected to a sheet conveyance path included in the sheet processing apparatus 200. As described above, the sheet processing apparatus 200 and the printing apparatus 100 included in the printing system 1000 itself are physically connected with each other. In addition, each of the printing apparatus 100 and the sheet processing apparatus 200 includes a central processing unit (CPU). The printing apparatus 100 and the sheet processing apparatus 200 can execute a data communication therebetween by using the CPU. In other words, the printing apparatus 100 and the sheet processing apparatus 200 are electrically connected with each other.

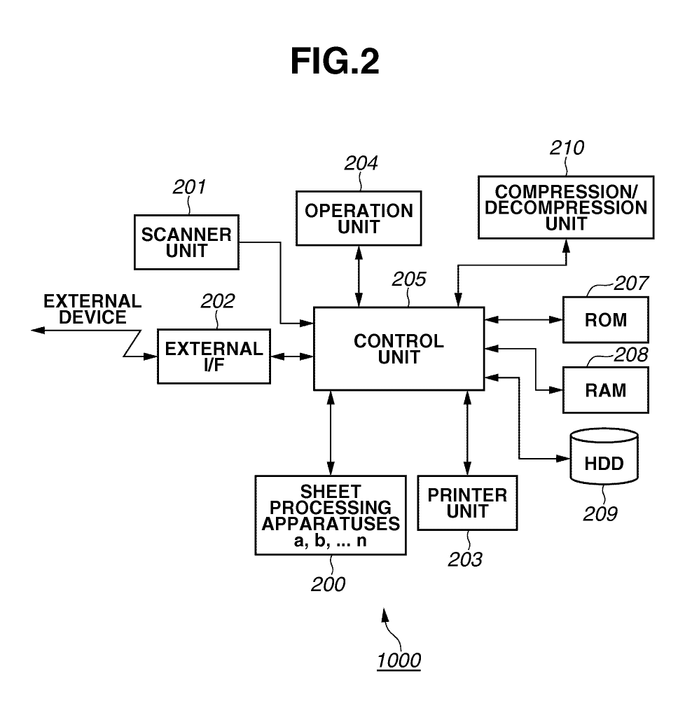

In the present exemplary embodiment, a control unit provided in the printing system centrally controls the printing apparatus 100 and the sheet processing apparatus 200. As an example of the control unit, a controller unit 205 (FIG. 2), which is provided in the printing apparatus 100, centrally controls the operation of the printing apparatus 100 and the sheet processing apparatus 200. In the present exemplary embodiment, the above-described sheet processing apparatuses are referred to as “post-processing apparatuses” or “postpresses”.

All the plurality of apparatus included in the POD system 10000 illustrated in FIG. 1 except the saddle stitch binding machine 110 are connected to a network 101 and can execute a data communication with one another via the network 101.

The printing apparatus 100 prints print data of a job to be processed, whose print execution request has been transmitted from a personal computer (PC). The personal computer transmitting the print execution request is an example of an external apparatus such as the server 103 and the client 104.

The server 103 manages all jobs to be processed within the POD system 10000 by executing a data communication with the other apparatuses by a network communication. To paraphrase this, the server 103 functions as a computer configured to centrally manage a series of processing of a work flow including a plurality of processing steps.

The server 103 determines a post-processing condition, which is to be used for finishing within the POD system 10000 according to an instruction for a job input by the operator. In addition, the server 103 transmits an instruction for executing post-processing (finishing) as desired by an end user (in the present exemplary embodiment, a customer who has requested to generate a print product). In instructing the post-processing, the server 103 exchanges information with each post-processing apparatus according to a command processed within the postpress and status information about the postpress by using information interchanging tool, such as job definition format (JDF).

An exemplary inner configuration (primarily the software configuration) of the printing system 1000 will be described in detail below with reference to a system block diagram of FIG. 2.

FIG. 2 is a block diagram illustrating an exemplary configuration of the printing system 1000 according to the present exemplary embodiment. According to the present exemplary embodiment, in the example illustrated in FIG. 2, units included in the printing system 1000 except the sheet processing apparatus 200 (to be precise, a group of serially connected sheet processing apparatuses, which can be constituted by a plurality of inline type sheet processing apparatuses) are included in the printing apparatus 100.

To paraphrase this, the sheet processing apparatus 200 is a sheet processing apparatus provided detachably from the printing apparatus 100 and can be provided as an optional apparatus to the printing apparatus 100. With the above-described configuration, a necessary number of inline finishers required in the POD environment can be provided. Accordingly, the printing apparatus 100 included in the printing system 1000 employs the following configuration.

Referring to FIG. 2, the printing apparatus 100 includes a non-volatile memory, such as a hard disk (hereinafter simply referred to as an “HD”) 209. The HD 209 can store data of a plurality of jobs to be processed. In addition, the printing apparatus 100 includes a copy function for printing job data, which is received from a scanner unit 201 included in the printing apparatus 100 itself, by using a printer unit 203 via the HD 209. Furthermore, the printing apparatus 100 includes a function for printing job data received from the external apparatus, such as the client 104, via an external interface (I/F) unit 202, which is an example of a communication unit, by using the printer unit 203 via the HD 209.

The printing apparatus 100 is an MFP type printing apparatus (also referred to as an image forming apparatus), which has the plurality of above-described functions. In other words, the printing apparatus according to the present exemplary embodiment, either a printing apparatus capable of executing color printing or a printing apparatus capable of executing monochromatic printing, can employ any configuration if the printing apparatus can execute various controls according to the present exemplary embodiment.

In the present exemplary embodiment, the printing apparatus 100 includes the scanner unit 201. The scanner unit 201 reads an image of a document and executes image processing on read image data. In addition, the printing apparatus 100 includes the external I/F unit 202, which is configured to transmit and receive to and from a facsimile apparatus, a network-connected apparatus, and an external dedicated apparatus.

In addition, the printing apparatus 100 includes the HD 209. The HD 209 can store image data of a plurality of jobs to be printed, which is received from either one of the scanner unit 201 and the external I/F unit 202. Furthermore, the printing apparatus 100 includes the printer unit 203, which is configured to execute print processing of data of the job to be processed, which is stored on the HD 209, on a print medium.

In addition, the printing apparatus 100 includes an operation unit 204, which is an example of a user interface (UI) unit included in the printing system 1000. The operation unit 204 includes a display unit. As another example of the UI unit provided in the printing system 1000, a display unit, a keyboard, and a mouse of the external apparatus, such as the server 103 and the client 104, are used.

The controller unit (a control unit or a CPU) 205, which is an example of the control unit provided in the printing system 1000, centrally controls processing and an operation executed by various units included in the printing system 1000.

A read-only memory (ROM) 207 stores various control programs necessary in the present exemplary embodiment, which includes a program for executing various processing according to the following flow charts. In addition, the ROM 207 stores a display control program configured to display various user interface screens (hereinafter referred to as “UI screens”) on the display unit of the operation unit 204, which includes UI screens illustrated in the drawings.

The control unit 205 loads and executes the program from the ROM 207 and controls the printing apparatus to execute various operations according to the present exemplary embodiment. In addition, the ROM 207 stores a program for executing an operation for analyzing page description language (PDL) data received from the server 103 and the client 104 via the external I/F unit 202 and for rasterizing the data into raster image data (bitmap image data). The above-described data and program are processed by software.

The ROM 207, which is a read-only memory, stores a program, such as a boot sequence or font information, and various programs including the above-described program. A random access memory (RAM) 208 is a rewritable memory. The RAM 208 stores image data transmitted from the scanner unit 201 and the external I/F unit 202 via a memory controller 206, various programs, and setting information.

The hard disk drive (HDD) 209 is a mass storage device configured to store image data compressed by a compression/decompression unit 210. The HDD 209 can store a plurality of pieces of data, such as print data of a job to be processed.

The control unit 205 executes control for printing data of a job to be processed, which is input by various input units, such as the scanner unit 201 or the external I/F unit 202, by using the printer unit 203 via the HDD 209. In addition, the controller unit 205 execute control for transmitting data of a job to be processed, which is input by various input units, such as the scanner unit 201 and the external I/F unit 202, to the external apparatus via the external I/F unit 202 and the HDD 209. As described above, the controller unit 205 executes control for executing various types of output processing for outputting data of the job to be processed, which is stored on the HDD 209. The compression/decompression unit 210 compresses or decompresses image data stored on the RAM 208 and the HDD 209 by using various compression methods, such as Joint Bi-level Image Experts Group (JBIG) or Joint Photographic Experts Group (JPEG).

In addition, in the present exemplary embodiment, the HDD 209 stores a plurality of templates used for printing variable data. Variable data refers to data which is loaded from a database, embedded into a predetermined region defined in a printing template, and printed. The database manages data, such as an address or an e-mail address of each customer. The database manages the data by using one record for one customer. With the above-described configuration, variable printing, in which a part of an image to be printed differs for each predetermined output, can be implemented.

A template to be used is designated in a received print job. Furthermore, the number of tab sheets used in printing a plurality of pieces of variable data is previously set to each template. With the above-described configuration, the controller unit 205, which is an example of an operation unit included in the printing system 1000, controls an operation of the inline type sheet processing apparatus 200 illustrated in FIG. 1.

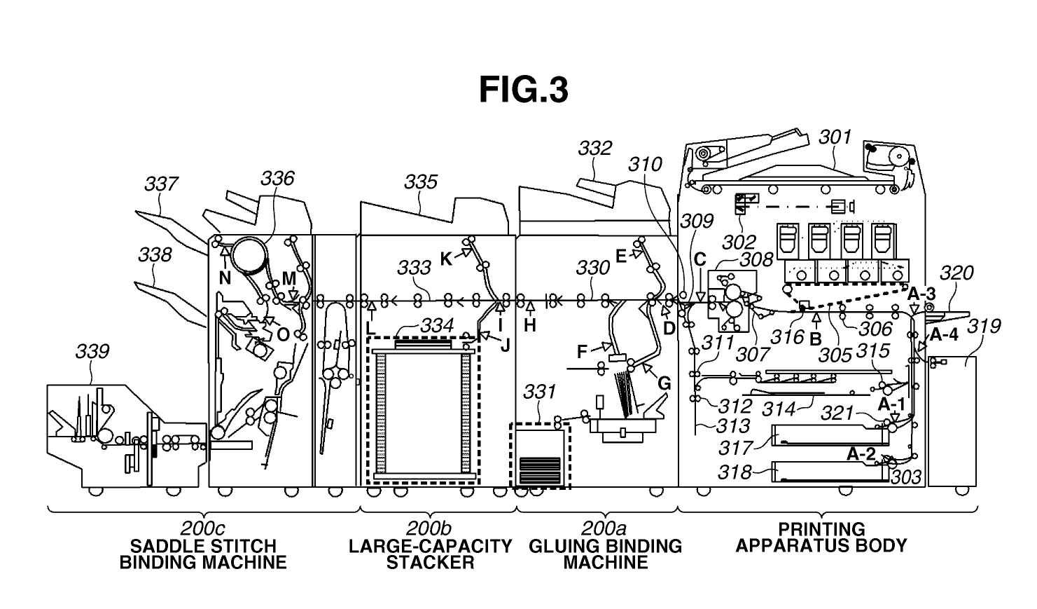

An exemplary mechanical configuration of the printing system 1000, which includes the above-described configuration, will be described in detail below with reference to FIG. 3.

An exemplary configuration of the printing system 1000 will be described in detail below with reference to a cross section illustrated in FIG. 3. FIG. 3 illustrates an exemplary inline configuration of the printing system 1000 according to the present exemplary embodiment. In the following description, the exemplary configuration of the printing system 1000 will be described in relation to an operation executed when a copy job is performed.

Referring to FIG. 3, an auto document feeder (ADF) 301 is provided in the scanner unit 201. The ADF 301 separates a document from a plurality of documents set by a user on a document tray one by one starting from a top of the plurality of documents and conveys the separated document onto a document mounting glass. A reading unit 302 reads an image of the document conveyed onto the document mounting glass by using an image sensor, such as a charge-coupled device (CCD). Furthermore, the reading unit 302 converts the read document image into image data. The converted image data is stored on the memory, such as the RAM 208 or the HDD 209, under control of the controller unit 205.

In printing variable data, which will be described in detail below, according to a result of an analysis on a print job received from an information processing apparatus, the controller unit 205 executes printing by feeding a tab sheet from a tab sheet feeding unit (paper feed stage).

The printing apparatus 100 has a configuration of a tandem type color printer including a plurality of photosensitive members (drums). In addition, the printing apparatus 100 includes a paper feed unit, such as paper feed cassettes 317 and 318 or a manual feed tray 320. A sheet is fed from any of the above-described paper feed units.

In addition, a paper feed deck 319, which is a paper feed unit, is connected to the printing apparatus 100. The paper feed deck 319 is capable of storing a large quantity of sheets. Accordingly, a sheet can be fed from the paper feed deck 319. The printing apparatus 100 executes control for stopping the sheet fed from any of the above-described paper feed units at registration rollers 306 to synchronize an operation for conveying the sheet with an operation of intermediate transfer belt 305.

When any sheet to which an image is to be transferred exists at the position of the registration rollers 306, a sheet to be used for a next printing operation can be fed from any one of the paper feed cassettes 317 and 318, the paper feed deck 319, and the manual feed tray 320. By feeding the sheet in the above-described manner, intervals between conveyance operations for conveying a plurality of sheets can be shortened. As a result, the productivity of the printing can be increased.

The image data temporarily stored on the RAM 208 and the HDD 209 is transferred to the printer unit 203. The image data is then converted by a laser recording unit (not illustrated) into recording laser light of each of four colors including yellow (Y), magenta (M), cyan (C), and black (K). The photosensitive drum of each color is irradiated with the recording laser light of each color and an electrostatic latent image, which corresponds to each color, is formed on the photosensitive drum. Furthermore, a toner image development operation is executed by using four-color toners supplied from a toner cartridge. Subsequently, visualized toner images are primarily transferred onto the intermediate transfer belt 305.

The intermediate transfer belt 305 rotates in a clockwise direction in FIG. 3. When the intermediate transfer belt 305 has rotated to a specific position, the conveyance of the sheet that has been stopped at the registration rollers 306 is started. The specific position is a position at which a substantial leading edge of the sheet is conveyed to a secondary transfer position 316 when the leading edge of the image transferred on the intermediate transfer belt 305 reaches the secondary transfer position 316. In the above-described manner, the toner images on the intermediate transfer belt 305 are transferred onto the sheet at the secondary transfer position 316.

The sheet having the toner images transferred thereon is then further conveyed by a belt 307. The toners are fixed on the sheet by pressure and heat applied thereto by a fixing device 308. After the sheet is conveyed through the sheet conveyance path, the sheet is discharged. A paper discharge flapper 309 can oscillate around an oscillation shaft. The paper discharge flapper 309 regulates the sheet conveyance direction. When the paper discharge flapper 309 has oscillated in the clockwise direction in FIG. 3 and is stationary at an oscillated position thereof, the sheet discharged from the fixing device 308 is then conveyed in a horizontal direction without changing its orientation to be conveyed by a paper discharge roller 310 to a gluing binding machine 200a. The gluing binding machine 200a is one of the sheet processing apparatuses 200. In the above-described manner, one-sided printing is executed.

On the other hand, in printing an image on both sides of the sheet, the paper discharge flapper 309 oscillates in the counterclockwise direction in FIG. 3 and stops at the counterclockwise-oscillated position. Subsequently, the direction of conveyance of the sheet discharged from the fixing device 308 is changed downwards to be conveyed into a two-sided conveyance unit. The two-sided conveyance unit includes a reverse flapper 311, a reverse flapper 311, reverse rollers 312, a reverse guide 313, and a two-sided tray 314.

The reverse flapper 311 oscillates around an oscillation shaft and regulates the sheet conveyance direction. In executing two-sided printing, the controller unit 205 executes control for oscillating the reverse flapper 311 in the counterclockwise direction in FIG. 3 and for conveying the sheet having the image printed on a first surface of the sheet into the reverse guide 313 via the reverse rollers 312.

The reverse rollers 312 are temporarily stopped in a state in which a trailing edge of the sheet is pinched by the reverse rollers 312, which are provided at an entrance to the reverse guide 313. Subsequently, the reverse flapper 311 is controlled to oscillate in the clockwise direction in FIG. 3 and the reverse rollers 312 are rotated in the reverse direction. In the above-described manner, the controller unit 205 executes control for conveying the sheet by a switch-back operation and for guiding the sheet onto the two-sided tray 314 in a state in which the leading edge and the trailing edge are set in the reverse orientation.

The sheet is temporarily stored on the two-sided tray 314. Subsequently, a paper refeed roller 315 again conveys the sheet to the registration rollers 306. At this timing, the sheet is conveyed to the registration rollers 306 in a state in which a second surface of the sheet, which is the opposite side of the first surface, on which the toners are transferred by a first-surface transfer process, faces the intermediate transfer belt 305.

Images are formed on the second surface of the sheet by a process similar to the first-surface transfer process. After the fixing device 308 fixes the images formed on the sheet second surface, the paper discharge roller 310 conveys the sheet having the images formed and fixed thereon to the gluing binding machine 200a, which is one of the sheet processing apparatuses 200. Two-sided printing is executed in the above-described manner.

In addition, sheet detection sensors are provided in the printing system 1000 at positions on each of the sheet conveyance paths provided in each of the printing apparatus 100, the gluing binding machine 200a, a large-capacity stacker 200b, and a saddle stitch binding machine 200c.

More specifically, the sheet detection sensors are provided at an entrance to and an exit from each apparatus and at a branch point and a confluence between the sheet conveyance paths. In the example illustrated in FIG. 3, an example of a position at which the sheet detection sensor is provided is illustrated by using a triangle mark. In other words, sheet detection sensors A through 0 are provided in the printing system 1000. According to a signal from each of the sheet detection sensors, the controller unit 205 detects whether a sheet conveyed via the sheet conveyance path is present and the position of the sheet if any is present.

For example, if a signal from a specific sheet detection sensor is continuously transmitted for specific time or longer, the controller unit 205 determines that a sheet stay jam (clogging) has occurred at a position corresponding to the sensor that currently and continuously transmits the signal. On the other hand, if a sheet that has passed a specific sheet detection sensor does not pass a next sheet detection sensor for specific time or longer, the controller unit 205 determines that a sheet delay jam (clogging) has occurred at a position between the positions of the specific sheet detection sensor and the next sheet detection sensor.

If a sheet jam (clogging) has occurred on the sheet conveyance path of the printing system 1000, the controller unit 205 executes control for suspending the current printing. In addition, the controller unit 205 executes control for displaying the position of the sheet to be removed and a method for removing the sheet as guidance information according to the signal from the sheet detection sensor.

The user can recognize the location of the sheet to be removed within the printing system 1000 according to the displayed information. In addition, the user opens a door of the apparatus and removes the sheet from the sheet conveyance direction according to the displayed guidance information.

After all jammed sheets are removed, the user inputs an instruction for resuming the printing via the operation unit 204. When the instruction for resuming the printing is received, the controller unit 205 executes control for resuming the printing. The printing is resumed starting from the printing on the sheet that is not normally discharged when the printing is suspended.

At a paper feed port of each paper feed unit, such as the paper feed cassettes 317 and 318, the paper feed deck 319, and the manual feed tray 320, sheet detection sensors (paper feed sensors) A-1, A-2, A-4, and A-3, which correspond to each of the paper feed units, respectively, are provided. The paper feed sensors detect a fed sheet, if any and transmit a sheet detection signal to the controller unit 205. The controller unit 205 counts the number of sheets fed from each paper feed unit according to the sheet detection signal received from the paper feed sensors.

The control unit 205 stores a count value on the RAM 208. The controller unit 205 can verify the number of sheets fed from each paper feed unit when a job is executed, by referring to the stored value.

In addition, a paper discharge sensor N is provided in the paper discharge unit 337 of the saddle stitch binding machine 200c. The paper discharge sensor N detects the sheet discharged to the paper discharge unit 337 and transmits a sheet discharge signal to the controller unit 205. The controller unit 205 counts the number of discharged sheets according to the received sheet discharge signal.

The control unit 205 stores a count value on the RAM 208. The controller unit 205 can verify the number of sheets discharged onto the sheet discharge unit 337 for the executed job according to the stored value.

In a case of the present exemplary embodiment, the printing apparatus 100 is a four-drum (4D) type color MFP. However, the configuration of the printing apparatus 100 is not limited to this. More specifically, a monochromatic MFP or a one-drum (1D) type color MFP can be used as the printing apparatus 100.

The operation and the configuration are described above, which are executed and employed when the printing system 1000 executes a copy job. On the other hand, in executing a print job, a printing operation similar to the operation described above is executed with the above-described configuration by using print data from the external I/F unit 202 instead of using image data from the scanner unit 201.

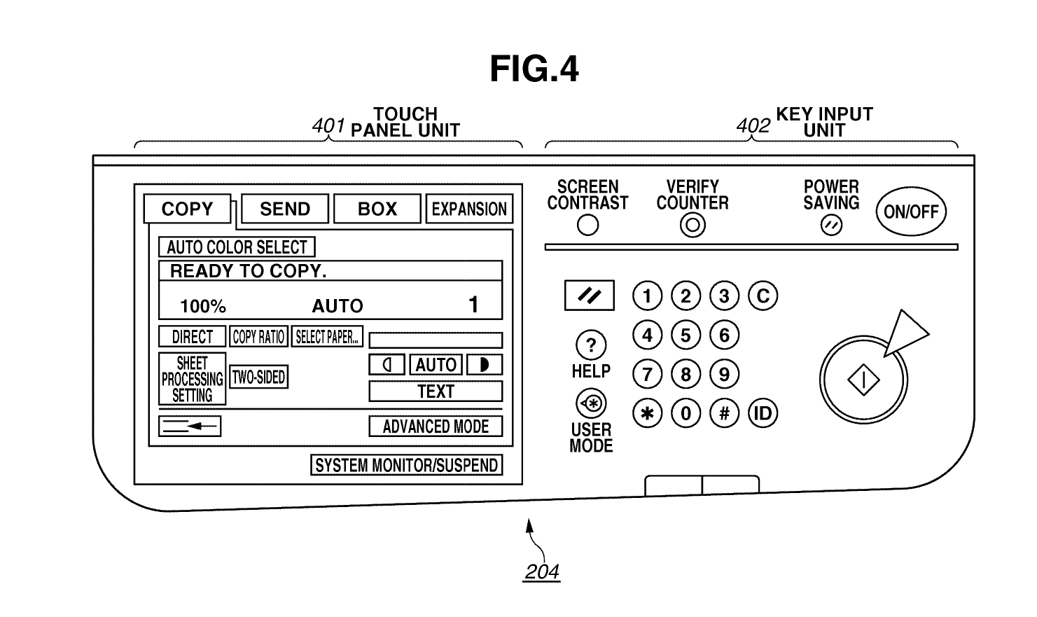

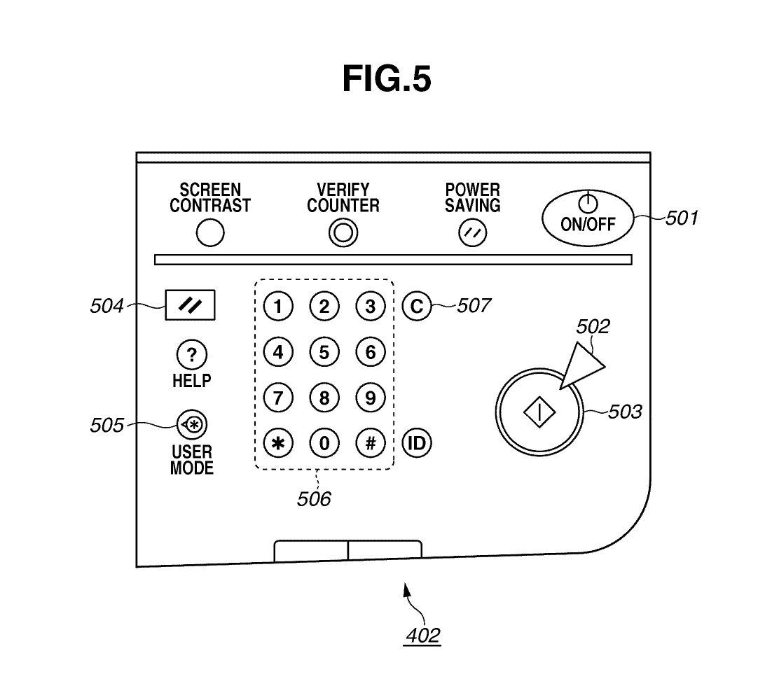

The operation unit 204, which is an example of the UI unit of the printing system 1000 and provided in the printing apparatus 100 of the printing system 1000, will be described in detail below with reference to FIGS. 4 and 5. FIGS. 4 and 5 are plan views illustrating an exemplary configuration of the operation unit 204 illustrated in FIG. 2.

Referring to FIG. 4, the operation unit 204 includes a key input unit 402 and a touch panel unit 401. The key input unit 402 can receive a user operation input by selecting a hard key. The touch panel unit 401 is an example of the display unit, which is capable of receiving a user operation input by selecting a soft key (display key).

Referring to FIG. 5, the key input unit 402 includes an operation unit power switch 501. According to a user operation of the operation unit power switch 501, the controller unit 205 executes control for selectively toggling between a standby mode and a sleep mode. The standby mode is a normal operation mode. In the sleep mode, the program is suspended in an interruption waiting state to be ready for executing network printing or facsimile transmission. In other words, the power consumption is saved in the sleep mode.

The controller unit 205 executes control for receiving a user operation of the operation unit power switch 501 when a main power switch (not illustrated), which is a switch for supplying power to the entire system, is pressed (an ON state). A start key 503 can be operated by the user to input an instruction to the printing apparatus for starting processing a job indicated by the user, such as a copy operation or a transmission operation of the job to be processed.

A stop key 502 is a key for receiving a user instruction for suspending the processing of the received job currently in process by the printing apparatus. Numeral keys 506 can be operated by the user to set a numerical value for various settings. A clear key 507 is a key for cancelling various parameters, such as a numerical value set by the user via the numeral keys 506.

A reset key 504 can be operated to disable various settings made by the user to the process target job and to receive a user instruction for returning the setting value to a default value. A user mode key 505 is a key for shifting the screen to a system setting screen provided in each user.

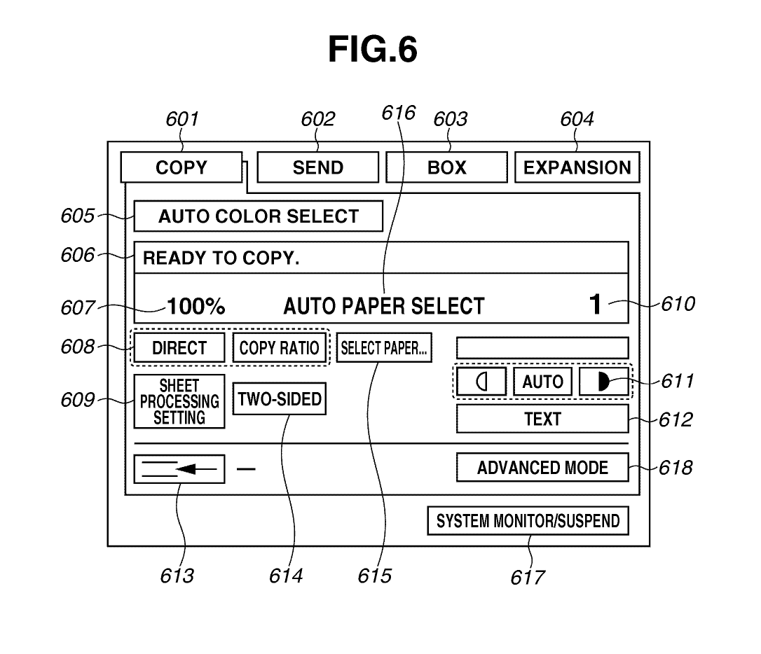

FIG. 6 illustrates the touch panel unit (hereinafter also referred to as a “display unit”) 401, which is an example of the UI unit provided by the printing system 1000. Referring to FIG. 6, the touch panel unit 401 includes a liquid crystal display (LCD) and a touch panel display, which is attached on the LCD and which includes a transparent electrode. The touch panel unit 401 includes both a function for receiving various settings input by the operator and a function for presenting information to the operator.

If it is detected that a position on the LCD corresponding to the display key displayed in an enabled state is pressed by the user, the controller unit 205 executes control for displaying an operation screen corresponding to the user operation of the key on the touch panel unit 401 according to the display control program previously stored on the ROM 207. FIG. 6 illustrates an example of an initial screen displayed on the touch panel unit 401 when the printing apparatus 100 is in the standby mode (a state in which no job is to be processed by the printing apparatus 100).

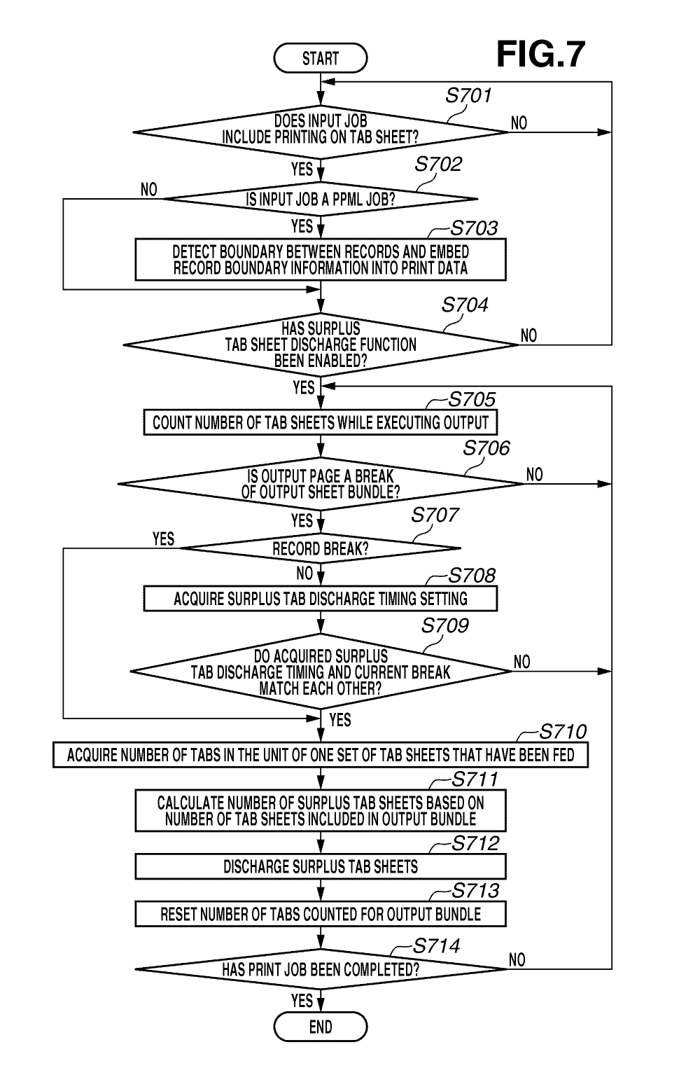

Assuming that the above-described configuration is employed, the controller unit 205, which is an example of the control unit included in the printing system 1000, executes control processing illustrated in the following flow chart of FIG. 7. An example of a characteristic flow of processing according to an exemplary embodiment, which is executed when a print job is input, will be described in detail below with reference to the flow chart of FIG. 7.

FIG. 7 is a flow chart illustrating an exemplary flow of processing executed by the printing apparatus 100 according to the present exemplary embodiment. Each step illustrated in the flow chart of FIG. 7 is executed by the controller unit 205 by loading and executing a program from the ROM 207 on the RAM 208.

Referring to FIG. 7, in steps S701 through S703, which are executed by the control unit 205 loading the program onto the RAM 208, the control unit 205 generates print data according to a result of analysis on a received print job. The processing for generating a page image and layout information about each page, which is executed by the analysis on the print job, will not be described in detail because the processing has no point to be characteristically emphasized.

Referring to FIG. 7, in step S701, the controller unit 205 determines whether the input job includes an instruction for using a tab sheet in the designated paper to be used, which is verified according to the analysis on the received print job. If it is determined that the job includes an instruction for using a tab sheet (YES in step S701), then the processing advances to step S702.

In step S702, the control unit 205 determines whether the received print job is a PPML job. If it is determined that the received print job is a PPML job (YES in step S702), then the processing advances to step S703. On the other hand, if it is determined that the received print job is not a PPML job (NO in step S702), then the processing advances to step S704.

In the present exemplary embodiment, the PPML job is generated by the server 103 and is transmitted to the printing apparatus 100. The PPML job includes information about a template to be used and variable data. The variable data includes information about one or more records (information about one customer) and information indicating a break of the record. The server 103 generates a PPML job including the above-described variable data and transmits the PPML job to the printing apparatus 100.

The information indicating the template to be used can be an image of the template itself. However, alternatively, the information indicating the template to be used can be information for designating a template stored on the HDD 209 of the printing apparatus 100. The printing apparatus 100 embeds the information about a record including the variable data included in the PPML job, in the designated template and prints the same.

In step S703, the control unit 205 detects a boundary between records included in the PPML job. The controller unit 205 embeds information about the break (i.e., the detected boundary between the records) as a break of print data. Then the processing advances to step S704.

The boundary between records can be detected by any appropriate conventional method. Accordingly, because the method for detecting the boundary between records has no point characteristic, the method will not be described in detail.

In step S704, the controller unit 205 acquires a setting for a surplus tab sheet discharge function from the HDD 209. If it is determined that the surplus tab sheet discharge function has been enabled (YES in step S704), then the processing advances to step S705. On the other hand, if it is determined that the surplus tab sheet discharge function has been disabled (NO in step S704), then the processing returns to step S701.

In step S705, the controller unit 205 transmits the print data and the image of each page generated in steps S701 through S703 to the printer unit 203. The printer unit 203 outputs the received print data and the image. The processing for printing the generated print data and the image by using the printer unit 203 has no pint characteristic. Accordingly, the processing will not be described in detail.

If the page data transferred to and output by the printer unit 203 is output on a tab sheet, the controller unit 205 increments the number of the output tab sheets. In addition, the controller unit 205 stores information about a paper feed stage from which the tab sheets have been fed on the RAM 208. Then the processing advances to step S706.

In step S706, the controller unit 205 detects the output page is a break in an output bundle. If it is determined that the output page is a break in the output bundle (YES in step S706), then the processing advances to step S707. On the other hand, if it is determined that the output page is not a break in the output bundle (NO in step S706), then the processing returns to step S705 to output a next page.

In step S707, the controller unit 205 determines whether the break detected in step S706 is a boundary between records. If it is determined that the break detected in step S706 is a boundary between records (YES in step S707), then the processing advances to step S710. On the other hand, if it is determined that the break detected in step S706 is a break other than a boundary between records (NO in step S707), then the processing advances to step S708.

The determination in step S707 is executed due to the following reason. Variable data corresponding to one job includes various types of breaks, such as a break for stapling, a break for shifting, and a break between copies, which is set when a plurality of copies is to be printed.

The control unit 205 executes surplus tab sheet discharge processing not when the break detected in step S706 is a break for stapling or a break for shifting but when the break detected in step S706 is a boundary between records. With the above-described configuration, the present exemplary embodiment can properly implement the surplus tab sheet discharge processing on each record.

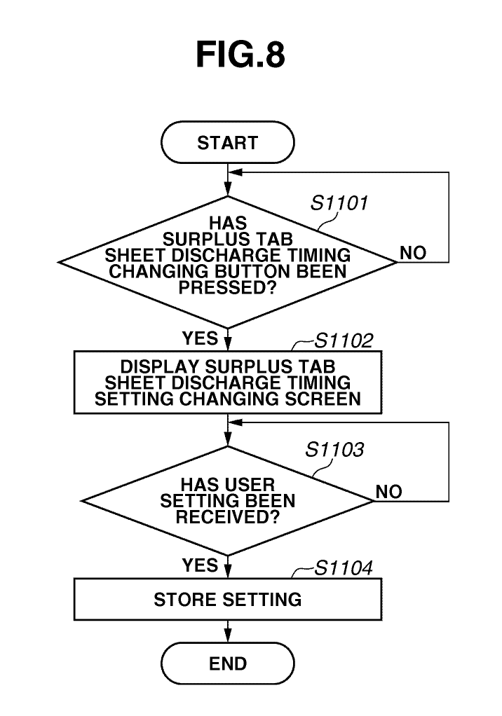

In step S708, the controller unit 205 acquires surplus tab sheet discharge timing setting information from the HDD 209. Then the processing advances to step S709. In the present exemplary embodiment, it is supposed that the setting of timing for discharging the surplus tab sheet is previously set according to a flow of processing illustrated in FIG. 8. The set surplus tab sheet discharge timing setting is previously stored on the HDD 209.

An exemplary method for setting the timing for discharging surplus tab sheet will be described in detail below with reference to a flow chart of FIG. 8. FIG. 8 is a flow chart illustrating an exemplary flow of processing executed by the printing apparatus 100 according to the present exemplary embodiment. In the following description, exemplary surplus tab sheet discharge timing setting processing, which is executed by the controller unit 205 loading a program corresponding to steps S1101 through S1104 on the RAM 208 will be described in detail.

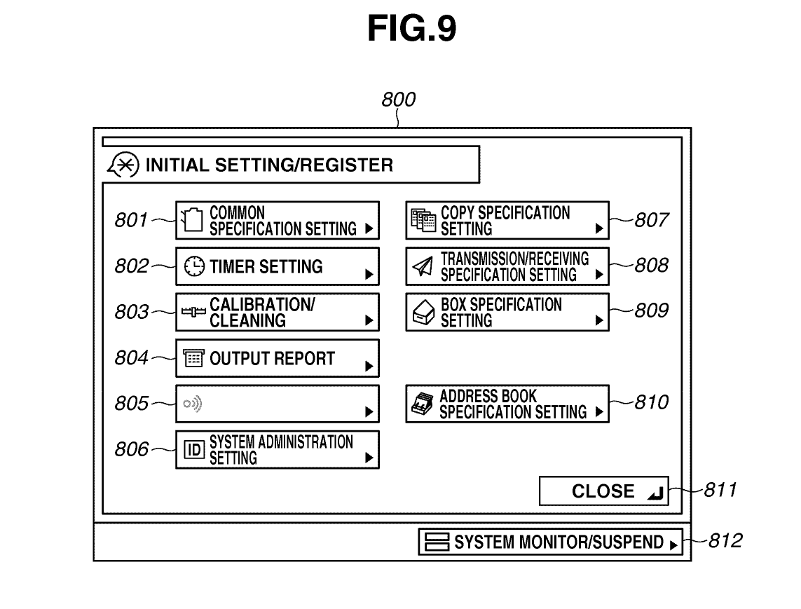

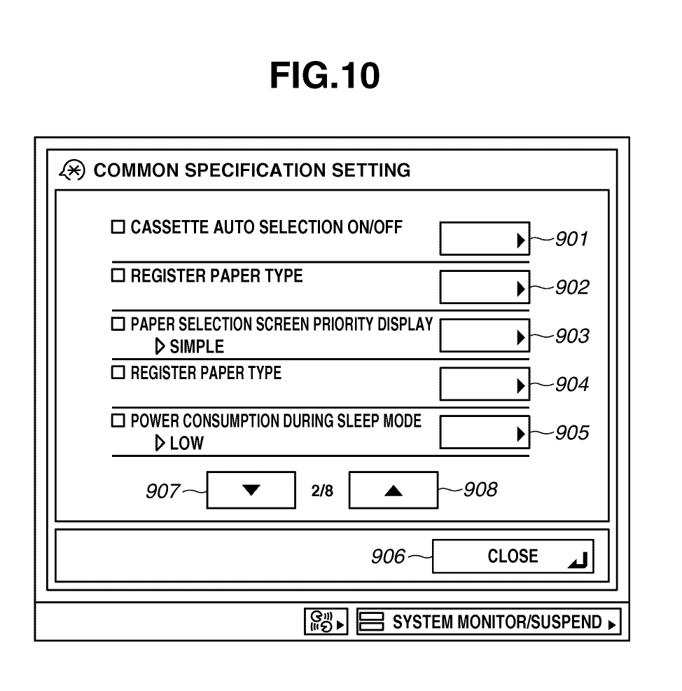

If it is determined that the user mode key 505 has been pressed by the user operating the operation unit 204, the controller unit 205 displays a user mode basic screen illustrated in FIG. 9 on the touch panel unit 401. If it is determined that a common specification setting button 801 has been pressed by the user via the user mode basic screen, the controller unit 205 displays a screen 900 for receiving common specification setting change, illustrated in FIG. 10.

Referring to FIG. 8, in step S1101, if it is determined that a surplus tab sheet discharge timing change button 902 has been pressed via the screen for receiving the common specification setting change (YES in step S1101), then the controller unit 205 determines that a request to change surplus tab sheet discharge timing, which is characteristic, has been received and the processing advances from step S1101 to step S1102 in the flow chart of FIG. 8.

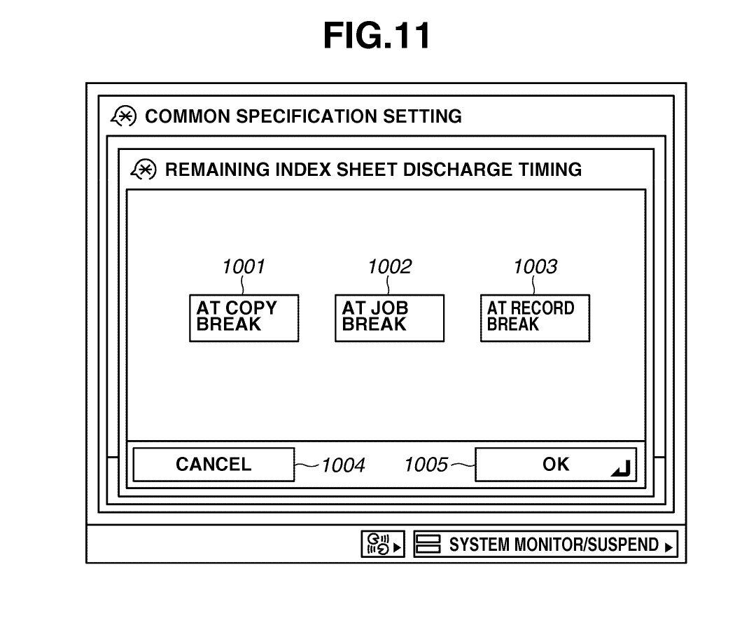

In step S1102, the control unit 205 displays a surplus tab sheet discharge timing setting screen illustrated in FIG. 11 on the touch panel unit 401. Then the processing advances to step S1103. The user sets the surplus tab sheet discharge timing via the surplus tab sheet discharge timing setting screen.

In step S1103, the control unit 205 stores settings of surplus tab discharge timing setting buttons 1001 through 1003 which are received in step S1102 on the RAM 208. If it is determined that an OK button 1005 has been pressed by the user (YES in step S1103), then the processing advances to step S1104. In addition, the controller unit 205 stores the surplus tab discharge timing setting from the RAM 208 on the HDD 209. Then the processing ends.

In the present exemplary embodiment, the surplus tab sheet discharge timing is stored on the HDD 209 of the printing apparatus 100 as described above. However, alternatively, the surplus tab sheet discharge timing can be previously set as an attribute of the job. More specifically, if it is recognized by the controller unit 205 as a result of the analysis on the received print job that the received print job has an attribute of a variable print job, the surplus tab sheet discharge timing is controlled in the following manner.

More specifically, even if the timing for inserting a tab paper using the UI screen illustrated in FIG. 11 is set between the or number of copies between the job, if the attribute of the received print job is the variable print job, the control unit 205 should perform control as follows. The controller unit 205 can change the timing for discharging the surplus tab sheet when the job is executed, to a timing between records. With the above-described configuration, because the timing for discharging the tab sheets is set at a timing between records if the received print job has an attribute of a variable print job, the present exemplary embodiment can effectively prevent the tab sheet of use from being inserted out of alignment when a plurality of records is printed. In the present exemplary embodiment, as described above, the controller unit 205 can acquire the surplus tab sheet discharge timing setting from the HDD 209.

Returning to FIG. 7 to describe the control executed in step S709 and beyond, in step S709, the controller unit 205 determines whether the acquired surplus tab sheet discharge timing setting matches the currently set break in the output bundle determined in step S706. If it is determined that the acquired surplus tab sheet discharge timing setting does not match the currently set break in the output bundle determined in step S706 (NO in step S709), then the processing returns to step S705 to output a next page. On the other hand, if it is determined that the acquired surplus tab sheet discharge timing setting matches the currently set break in the output bundle determined in step S706 (YES in step S), then the processing advances to step S710.

In step S710, the controller unit 205 acquires information about the paper feed stage that has fed the tab sheets used in the print job that is currently in printing, from the RAM 208. In addition, the controller unit 205 acquires the number of tab sheets included in one set of tab sheets set to the paper feed stage, from the HDD 209.

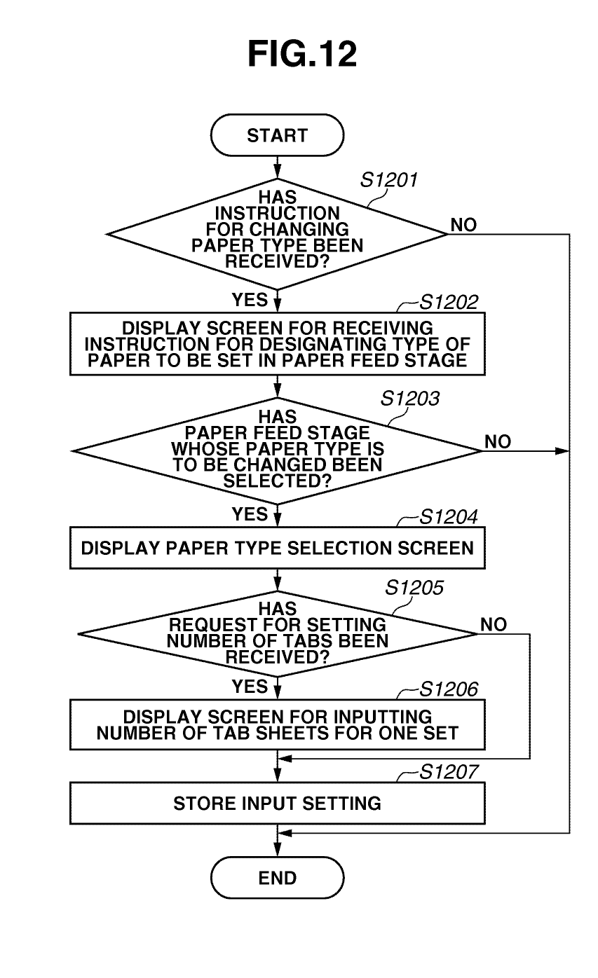

In the present exemplary embodiment, it is supposed that the number of tab sheets included in one set of tab sheets is previously set. An exemplary flow of processing for setting the number of tab sheets included in one set of tab sheets will be described in detail below with reference to a flow chart of FIG. 12.

FIG. 12 is a flow chart illustrating an exemplary flow of processing executed by the printing apparatus 100 according to the present exemplary embodiment.

In the following description, exemplary processing for setting the number of tab sheets included in one set of surplus tab sheets, which is executed by the controller unit 205 by loading a program corresponding to steps S1201 through S1207 on the RAM 208, will be described in detail.

If it is determined that the user mode key 505 has been pressed by the user operating the operation unit 204, the controller unit 205 displays the user mode basic screen 800 illustrated in FIG. 9 on the touch panel unit 401. If it is determined that the common specification setting button 801 has been pressed via the user mode basic screen 800, the controller unit 205 displays the screen 900 for receiving common specification setting change illustrated in FIG. 10 on the touch panel unit 401.

Referring to FIG. 12, in step S1201, if it is determined that a paper type registration button 904 has been pressed via the screen 900 for receiving common specification setting change (YES in step S1201), then the controller unit 205 determines that a paper type changing request as to a paper set in the paper feed stage has been received and the processing advances from step S1201 to step S1202 in the flow chart of FIG. 12. In the example illustrated in FIGS. 10 and 11, an “index sheet” corresponds to the tab sheets according to the present exemplary embodiment.

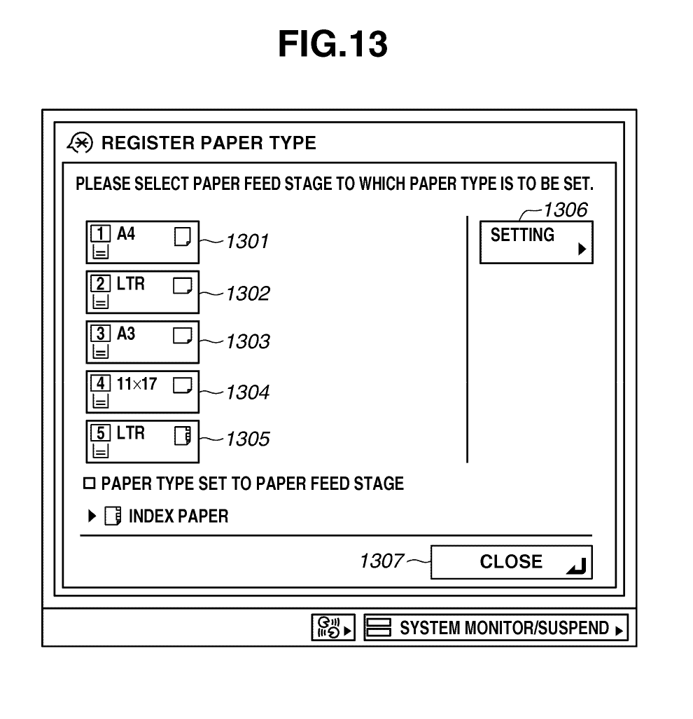

In step S1202, the control unit 205 displays a target paper feed stage selection screen for paper type change illustrated in FIG. 13 on the touch panel unit 401. Then the processing advances to step S1203. In step S1203, if it is determined that a paper feed stage setting button 1301, 1302, 1303, 1304, or 1305 for paper type change has been pressed (YES in step S1203), then the controller unit 205 stores the received setting of the paper feed stage on the RAM 208. If it is determined that a setting button 1306 has been pressed, the processing advances to step S1204.

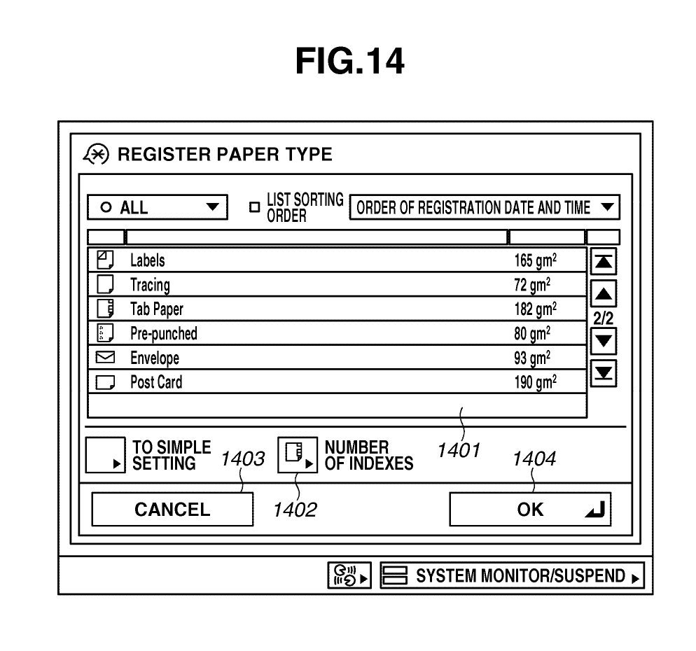

In step S1204, the control unit 205 displays a paper type selection screen illustrated in FIG. 14 on the touch panel unit 401 to allow the user to select the type of paper from among those included in a paper type selection list 1401. Then the processing advances to step S1205.

In step S1205, the control unit 205 stores the selected sheet type on the RAM 208. If a tab paper has been selected, the controller unit 205 displays a tab quantity setting change button 1402, by which the number of tab sheets to be included in one set of tab sheets can be set, on the touch panel unit 401.

If it is determined that a request for changing the tab quantity setting has been received (YES in step S1205), then the processing advances to step S1206. After that, if an OK button 1404 is pressed, the processing advances to step S1207.

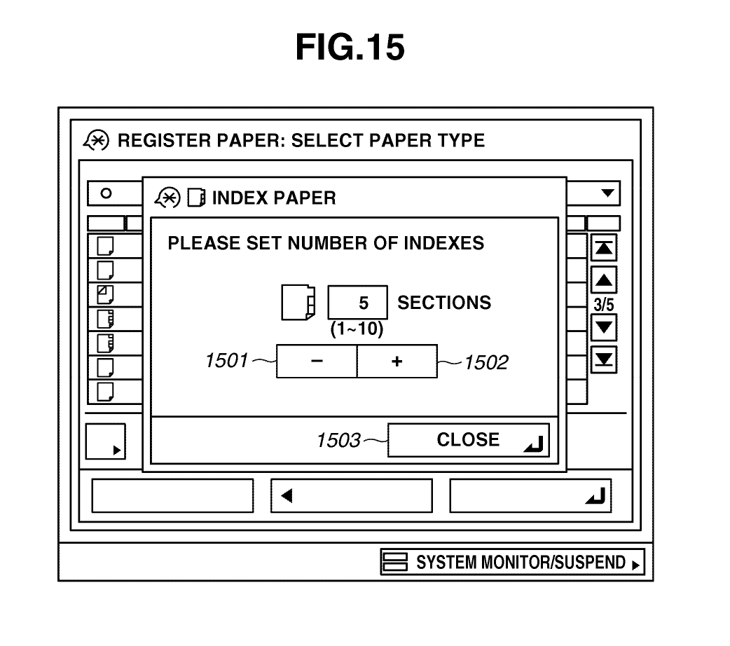

In step S1206, the control unit 205 displays a tab quantity setting screen illustrated in FIG. 15 on the touch panel unit 401. If the tab quantity change is input by operating a setting change button 1501 or 1502 and if the user presses a “close” button 1503, the controller unit 205 stores the received tab quantity (number of tabs) on the RAM 208. Then the processing advances to step S1207.

In step S1207, the control unit 205 loads the setting stored in steps S1205 and S1206 from the RAM 208 on the HDD 209. Then the processing ends. With the above-described configuration, the present exemplary embodiment can acquire the number of tab sheets included in one set of tab sheets set to the paper feed stage stored on the HDD 209.

Returning to FIG. 7 to describe the control executed in step S711 and beyond, in step S711, the controller unit 205 compares the number of tab sheets used in the current printing among one set of the tab sheets and the number of tab sheets that have been output, counted, and stored on the RAM 208, to calculate the number of tab sheets which are the surplus tab sheets. Then the processing advances to step S712.

In step S712, the controller unit 205 acquires the paper feed stage that has fed the tab sheets used in the print job and has been stored in step S705, from the RAM 208. The controller unit 205 executes paper discharge control for discharging the tab sheets from the paper feed stage based on the number of surplus tab sheets calculated in step S711. Then the processing advances to step S713.

After completely discharging the surplus tab sheets, the controller unit 205, in step S713, resets the count value of tab sheets used in the printing, which has been stored on the RAM 208 in step S705. Then the processing advances to step S714.

In step S714, the control unit 205 determines whether the print job has been completed. If it is determined that the print job has not been completely executed (NO in step S714), then the processing returns to step S705 to output a next page. On the other hand, if it is determined that the print job has been completed (YES in step S714), then the processing ends.

In the present exemplary embodiment, the tab sheets are stored in the paper feed unit of the printing apparatus body 100 illustrated in FIG. 3 and are fed. However, alternatively, an embodiment can also be implemented and applied if tab sheets are fed and inserted from a sheet feed unit, such as an inserter.

With the above-described configuration, the present exemplary embodiment can discharge a surplus tab sheet at a timing of a break between records even when a variable print job including an instruction for printing on a tab sheet is to be executed. Accordingly, the present exemplary embodiment can save the trouble of the user for removing the surplus tab sheet. As a result, the present exemplary embodiment can provide an effective system.

### Other Embodiments

Aspects can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium). In an example, a computer-readable medium may store a program that causes a printing apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-202570 filed Sep. 10, 2010, which is hereby incorporated by reference herein in its entirety.

What is claimed is:

1. A printing apparatus configured to feed tab sheets from one set of a plurality of tab sheets and to feed a sheet of paper other than tab sheets and configured to execute printing by using the fed tab sheet or the fed sheet of paper other than the tab sheet, the printing apparatus comprising:
an analysis unit configured to analyze a received print job;
a feeding unit configured, in performing printing by executing the print job analyzed by the analysis unit and by inserting variable data of a plurality of records into a predetermined template, to feed the tab sheet at a break of the variable data, wherein the variable data is detected according to a result of the analysis by the analysis unit on the print job;
a discharge unit configured to discharge, to an outside of the printing apparatus, a tab sheet that is included in one set of tab sheets and remains unfed by the feeding unit; and
a discharge control unit configured, every time variable data of one record from among the plurality of records is printed, to execute control to cause the discharge unit to discharge, to the outside of the printing apparatus, the tab sheet that is included in the one set of tab sheets and remains unfed by the feeding unit.

2. The printing apparatus according to claim 1, further comprising a calculation unit configured to calculate a number of tab sheet remaining unfed based on a stored number of tab sheets to be fed corresponding to a predetermined template and a number of tab sheets fed by the feeding unit, wherein the discharge unit is configured to discharge, to an outside of the printing apparatus, the tab sheet that is included in the one set of tab sheets and remains unfed, which is calculated by the calculation unit.

3. The printing apparatus according to claim 1, further comprising a setting unit configured to set a timing for discharging the tab sheet to a timing between jobs, a timing between records, or a timing between copies.

4. The printing apparatus according to claim 3, wherein the discharge control unit is configured, if it is verified as a result of the analysis by the analysis unit that the received print job has an attribute of a variable print job, to change the timing for discharging the tab sheet to the timing between records even if a timing for inserting the tab sheet, which has been set by the setting unit, is the timing between jobs or the timing between copies.

5. A method for controlling a printing apparatus configured to feed tab sheets from one set of a plurality of tab sheets and to feed a sheet of paper other than tab sheets and configured to execute printing by using the fed tab sheet or the fed sheet of paper other than the tab sheet, the method comprising:
analyzing a received print job;
feeding, in performing printing by executing the analyzed print job and by inserting variable data of a plurality of records into a predetermined template, the tab sheet at a break of the variable data, wherein the variable data is detected according to a result of the analysis on the print job;
discharging, to an outside of the printing apparatus, a tab sheet that is included in one set of tab sheets and remains unfed every time variable data of one record from among the plurality of records is printed.

6. A non-transitory computer-readable medium storing a program causing printing apparatus to perform a method according to claim 5.
